(19) United States
(12) Patent Application Publication
(10) Pub. No.: US 2017/0064761 A1
(43) Pub. Date: Mar. 2, 2017

(54) OPTIMIZED SELECTION OF TECHNOLOGY TO DECODE CELL BROADCAST MESSAGE IN MULTI-SIM MOBILE COMMUNICATION DEVICE TO IMPROVE SYSTEM PERFORMANCE

(71) Applicant: QUALCOMM Incorporated, San Diego, CA (US)

(72) Inventors: Mukesh Kumar, Dinanagar (IN); Suresh Sanka, Hyderabad (IN)

(21) Appl. No.: 14/836,786

(22) Filed: Aug. 26, 2015

(51) Int. Cl. H04W 76/02; H04W 36/14; H04W 72/12; H04W 8/18

(52) U.S. Cl. CPC H04W 76/026; H04W 8/18; H04W 36/14; H04W 72/1278; H04W 88/06

(57) ABSTRACT

A method for decoding a cell broadcast (CB) message in a multi-subscriber identity module (SIM) mobile communication device, the method includes: receiving a first CB decoding schedule for a first subscription associated with a first radio access technology (RAT) of the mobile communication device; receiving a second CB decoding schedule for a second subscription associated with a second RAT of the mobile communication device; selecting one subscription from the first subscription and the second subscription; and decoding a CB message on a RAT associated with the selected subscription in accordance with a CB decoding schedule of the selected subscription.

### BACKGROUND

A cellular communication network may transmit broadcast (CB) messages to all mobile communication devices within range simultaneously in response to urgent or rapidly changing situations. For example, a cellular communication network may send out earthquake warnings, severe weather warnings, missing child alerts, and other messages requiring widespread dissemination to as many individual mobile communication devices as possible. The same CB message may be broadcast across multiple communication networks and multiple radio access technologies (RATs) simultaneously.

A multi-subscriber identity module (SIM) multi-standby (MSMS) mobile communication device may receive a separate, identical copy of the CB message on different subscriptions associated with each of the multiple SIMs (i.e., multiple identical copies of the same CB message may be received). In some cases, the mobile communication device is required to always decode the CB message irrespective of the RAT used to receive the message. Accordingly, multiple copies of the same CB message received by the MSMS mobile communication device would require separate decoding.

The MSMS mobile communication device may handle decoding on a first come, first serve basis (i.e., the MSMS mobile communication device decodes the first received CB message even if the CB message is received on a subscription that is currently inactive) in accordance with a CB schedule set by the communication network associated with each RAT. Since in an MSMS mobile communication device all of the subscriptions share a single Radio Frequency (RF) chain, the MSMS mobile communication device may tune away from an active subscription to decode the CB message on the previously inactive subscription in accordance with CB scheduling of the inactive subscription. However, the same CB message will also be decoded on the active subscription. Tuning away to redundantly decode the same information multiple times may negatively affect throughput of the active subscription.

### SUMMARY

Apparatuses and methods for optimizing selection of a RAT to decode cell broadcast message in a multi-sim mobile communication device are provided.

According to various embodiments there is provided a method for decoding a cell broadcast (CB) message in multi-subscriber identity module (SIM) mobile communication device. In some embodiments, the method may include: receiving a first CB decoding schedule for a first subscription associated with a first radio access technology (RAT) of the mobile communication device, receiving a second CB decoding schedule for a second subscription associated with a second RAT of the mobile communication device, selecting one subscription from the first subscription and the second subscription, and decoding a CB message on a RAT associated with the selected subscription in accordance with a CB decoding schedule of the selected subscription.

According to various embodiments there is provided a multi-subscriber identity module (SIM) mobile communication device for decoding a cell broadcast (CB) message. In some embodiments, the mobile communication device may include: a communication unit configured for communication with a first communication network using a first radio access technology (RAT) and communication with a second communication network using a second RAT, and a control unit. The control unit may be configured with processor-executable instructions to: receive a first CB decoding schedule for a first subscription associated with the first RAT of the mobile communication device, receive a second CB decoding schedule for a second subscription associated with the second RAT of the mobile communication device, select one subscription from the first subscription and the second subscription, and decode a CB message on a RAT associated with the selected subscription in accordance with a CB decoding schedule of the selected subscription.

According to various embodiments there is provided a non-transitory computer readable medium. In some embodiments, the non-transitory computer readable medium may include a program for making a computer execute a method of decoding a cell broadcast (CB) message in multi-subscriber identity module (SIM) mobile communication device. The program may include computer executable instructions performing operations including: receiving a first CB decoding schedule for a first subscription associated with a first radio access technology (RAT) of the mobile communication device, receiving a second CB decoding schedule for a second subscription associated with a second RAT of the mobile communication device, selecting one subscription from the first subscription and the second subscription, and decoding a CB message on a RAT associated with the selected subscription in accordance with a CB decoding schedule of the selected subscription.

According to various embodiments there is provided a multi-subscriber identity module (SIM) mobile communication device for decoding a cell broadcast (CB) message. In sonic embodiments, the mobile communication device may include: means for receiving a first CB decoding schedule for a first subscription associated with a first radio access technology (RAT) of the mobile communication device, means for receiving a second CB decoding schedule for a second subscription associated with a second RAT of the mobile communication device, means for selecting one subscription from the first subscription and the second subscription, and means for decoding a CB message on a RAT associated with the selected subscription in accordance with a CB decoding schedule of the selected subscription.

### BRIEF DESCRIPTION OF THE DRAWINGS

Aspects and features of the various embodiments will be more apparent by describing example embodiments with reference to the accompanying drawings, in which:

FIG. 1A is a block diagram illustrating a mobile communication device according to various embodiments;

FIG. 1B is a diagram illustrating a network environment for various embodiments;

FIGS. 2A and 2B illustrate a flowchart for a method to optimize selection of technology to decode a CB message in a mobile communication device according to various embodiments;

FIG. 3 is a diagram illustrating scheduled RAT activity on an inactive subscription of a mobile communication device according to various embodiments; and

FIG. 4 is a diagram illustrating actual RAT activity of an inactive subscription of a mobile communication device according to various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

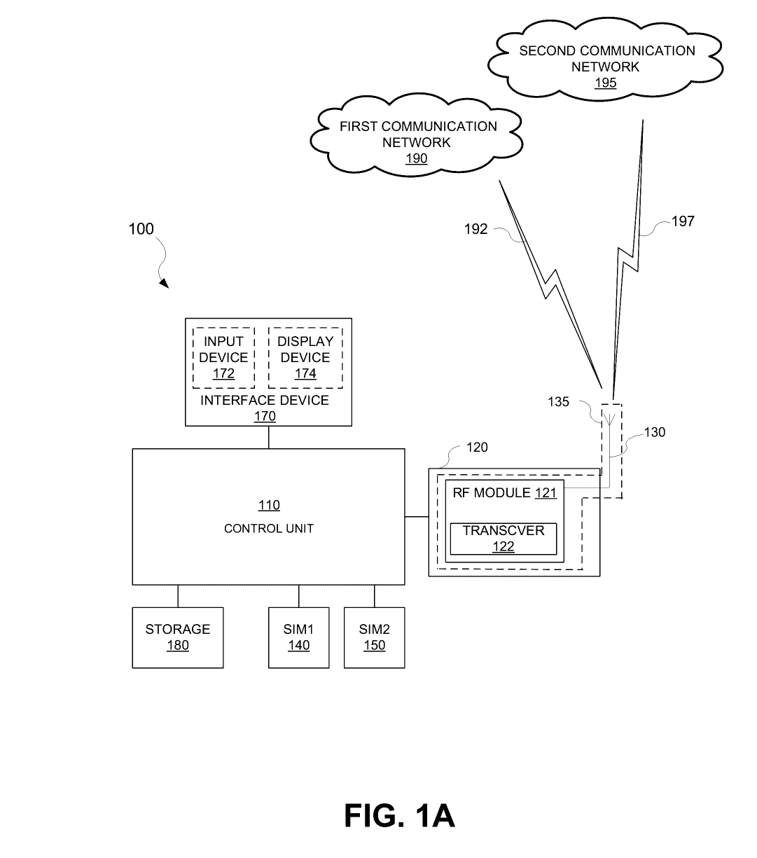

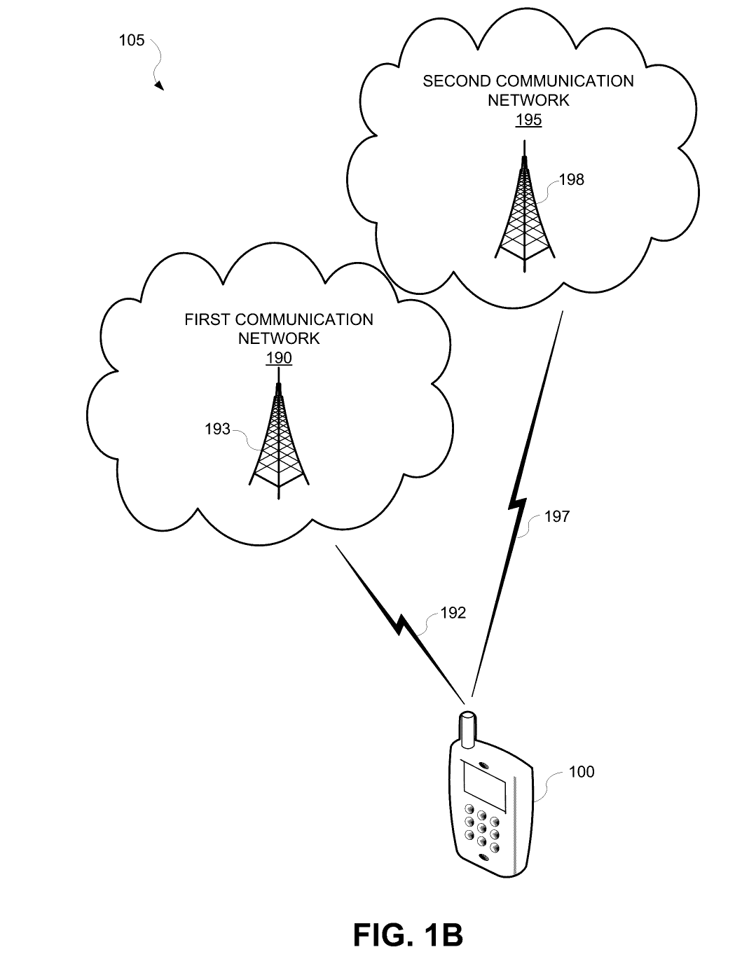

FIG. 1A is a block diagram illustrating a mobile communication device 100 according to various embodiments. As illustrated in FIG. 1A, the mobile communication device 100 may include a control unit 110, a communication unit 120, an antenna 130, a first SIM 140, a second SIM 150, an interface device 170, and a storage unit 180.

The mobile communication device 100 may be, for example but not limited to, a mobile telephone, smartphone, tablet, computer, etc., capable of communication with one or more wireless networks. One of ordinary skill in the art will appreciate that the mobile communication device 100 may include one or more transceivers communication units) and may interface with one or more antennas without departing from the scope of the various embodiments.

The communication unit 120 may include, for example, but not limited to, one or more radio frequency (RE) modules 121. The RE module 121 may include, for example, but not limited to the first transceiver 122. An RE chain 135 may include, for example, but not limited to the antenna 130 and the RE module 121.

One of ordinary skill in the art will appreciate that embodiments of the mobile communication device 100 may include more than one communication unit 120 and/or more than one antenna 130 without departing from the scope of the various embodiments.

A SIM (for example the first SIM 140 and/or the second SIM 150) in various embodiments may be a Universal Integrated Circuit Card (UICC) that is configured with SIM and/or universal SIM (USIM) applications, enabling access to global system for mobile communication (GSM) and/or universal mobile telecommunications system (UMTS) networks. The UICC may also provide storage for a phone book and other applications. Alternatively, in a Code Division Multiple Access (CDMA) network, a SIM may be a UICC removable user identity module (R-UIM) or a CDMA subscriber identity module (CSIM) on a card. A SIM card may have a CPU, ROM, RAM, EEPROM and I/O circuits. An integrated Circuit Card Identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an IMSI, a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The first SIM 140 may associate the communication unit 120 with a first subscription (Sub1) 192 associated with a first radio access technology (RAT) on a first communication network 190 and the second SIM 150 may associate the communication unit 120 with a second subscription (Sub2) 197 associated with a second RAT on a second communication network 195. When a RAT is active, the communication unit 120 receives and transmits signals on the active RAT. When a RAT is idle, the communication unit 120 receives but does not transmit signals on the idle RAT.

For convenience, the various embodiments are described in terms of dual-SIM dual-standby (DSDS) mobile communication devices. However, one of ordinary skill in the art will appreciate that the various embodiments may be extended to Multi-SIM Multi-Standby (MSMS) and/or Multi-SIM Multi-Active (MSMA) mobile communication devices without departing from the scope of protection.

The first communication network 190 and the second communication network 195 may be operated by the same or different service providers, and/or may support the same or different RATs, for example, but not limited to, GSM, CDMA, WCDMA, and Long Term Evolution (LTE).

The interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the various embodiments.

The control unit 110 may be configured to control overall operation of the mobile communication device 100 including control of the communication unit 120, the interface device 170, and the storage unit 180. The control unit 110 may be a programmable device, for example, but not limited to, a microprocessor (e.g., general-purpose processor, baseband modem processor, etc.) or microcontroller.

The storage unit 180 may be configured to store operating systems and/or application programs for operation of the mobile communication device 100 that are executed by the control unit 110, as well as to store application data and user data.

FIG. 1B is a diagram illustrating a network environment 105 for various embodiments. Referring to FIGS. 1A and 1B, a mobile communication device 100 may be configured to communicate with a first communication network 190 on a first subscription 192 and a second communication network 195 on a second subscription 197. One of ordinary skill in the art will appreciate that the mobile communication device may configured to communicate with more than two communication networks and may communicate on more than two subscriptions without departing from the scope of the various embodiments.

The first communication network 190 and the second communication network 195 may implement the same or different radio access technologies (RATS). For example, the first communication network 190 may be a GSM network and the first subscription 192 may be a GSM subscription. The second communication network 195 may also be a GSM network. Alternatively, the second communication network 195 may implement another RAT including, for example, but not limited to, LTE, Wideband Code Division Multiple Access (WCDMA), and Time Division-Synchronous Code Division Multiple Access (TD-SCDMA).

The first communication network 190 may include one or more base transceiver stations (BTSs) including, for example, but not limited to, a first BTS 193. The second communication network 195 may also include one or more BTSs, including, for example, but not limited to, a second BTS 198. A person having ordinary skill in the art will appreciate that the network environment 105 may include any number of communication networks, mobile communication devices, and BTSs without departing from the scope of the various embodiments.

The mobile communication device 100 may attempt to acquire the first communication network 190 and camp on the first BTS 193. The mobile communication device 100 may also attempt to acquire the second communication network 195 and camp on the second BTS 198. A person having ordinary skill in the art will appreciate that the acquisition of the first communication network 190 performed on the first subscription 192 may be independent of the acquisition of the second communication network 195 performed on the second subscription 197. Furthermore, the mobile communication device 100 may attempt to acquire the first communication network 190 on the first subscription 192 and the second communication network 195 on the second subscription 197.

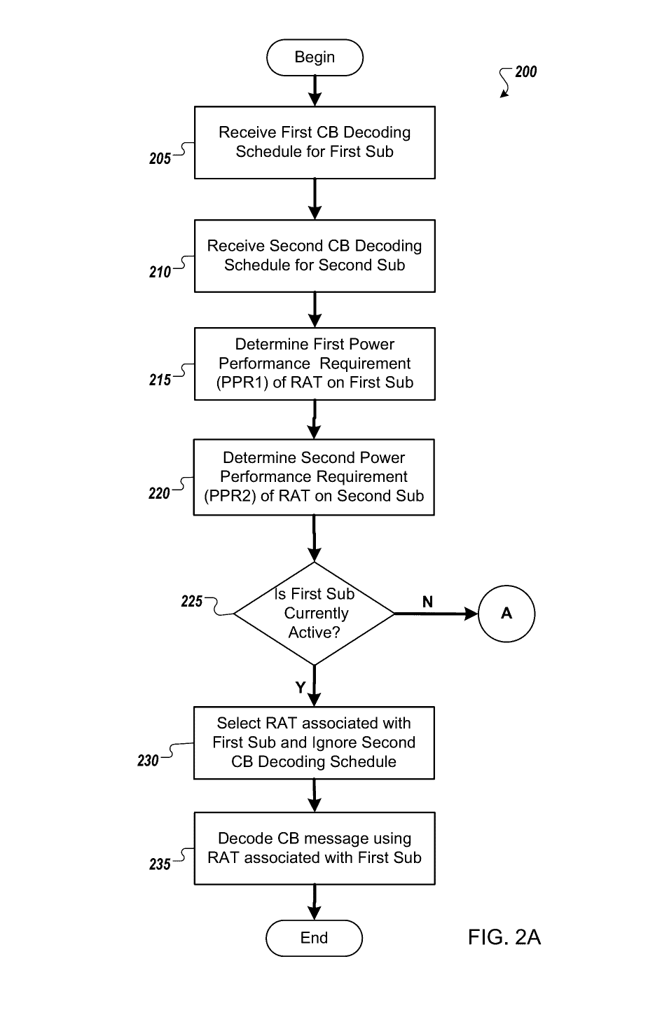

FIGS. 2A and 2B illustrate a flowchart for a method 200 to optimize selection of technology to decode a CB message in a mobile communication device (e.g., 100 in FIGS. 1A-1B) according to various embodiments. Referring to FIGS. 1A-2B, at block 205, the communication unit 120 of the mobile communication device 100 may receive a first CB decoding schedule, which includes a CB message, for a first subscription (e.g., Sub1 192) associated with the first communication network 190. For example, the mobile communication device 100 may receive the first CB decoding schedule including the CB message from a BTS (e.g., the first BTS 193) associated with the first communication network 190.

In some example embodiments, the mobile communication device 100 may receive the first CB decoding schedule via System Information Blocks (SIBs) transmitted by the first BTS 193 when the mobile communication device 100 camps on the first BTS 193. In other example embodiments, the mobile communication device 100 may receive the first CB decoding schedule including the CB message in a CB page request transmitted by the first BTS 193. The mobile communication device 100 may also receive the first CB decoding schedule including the CB message in any other manner that may be apparent to a person of ordinary skill in the art.

At block 210, the communication unit 120 may receive a second CB decoding schedule, which includes a CB message, for a second subscription (e.g., Sub2 195) associated with the second communication network 195. For example, the mobile communication device 100 may receive the second CB decoding schedule including the CB message from a BTS (e.g., the second BTS 198) associated with the second communication network 195.

In some example embodiments, the mobile communication device 100 may receive the second CB decoding schedule including the CB message via SIBs transmitted by the second BTS 198 during initial connection of the mobile communication device 100 to the second BTS 198. In other example embodiments, the mobile communication device 100 may receive the second CB decoding schedule including the CB message in a CB page request transmitted by the second BTS 198. The mobile communication device 100 may also receive the second CB decoding schedule including the CB message in any other manner that may be apparent to a person of ordinary skill in the art.

At the block 215, the control unit 110 of the mobile communication device 100 may determine a first power performance requirement (PPR1) of a RAT on Sub1 192. PPR1 may represent the product of: (1) the time (T1) required to decode the CB message using the RAT on the Sub1 192 and (2) the current consumption rate (I1) required to decode the CB message using the RAT on Sub1 192 (i.e., PPR1=T1*I1). In some example embodiments, the control unit 110 may measure T1 and I1 in real time during decoding of the CB message using the RAT on Sub1 192 and calculate PPR1 based on the measurements taken in real time. In other example embodiments, the control unit 110 may calculate the PPR1 based on previously measured T1 and I1 values stored in time and current consumption rate tables stored in the storage unit 180. In still other example embodiments, the control unit 110 may not take any measurements or perform any calculations. Instead, the control unit 110 may look up the PPR1 from a Power Performance Requirement table stored in the storage unit 180.

At block 220, the control unit 110 may determine a second power performance requirement (PPR2) of a RAT on Sub2 197. PPR2 may represent the product of: (1) the time (T2) required to decode the CB message using the RAT on Sub2 197 and (2) the current consumption rate (I2) required to decode the CB message using the RAT on Sub2 197 (i.e., PPR2=T2*I2). In some example embodiments, the control unit 110 may measure T2 and I2 in real time during decoding of the CB message using the RAT on Sub2 197 to calculate PPR2 based on the measurements taken in real time. In other example embodiments, the control unit 110 may calculate the PPR2 based on previously measured T2 and I2 values stored in time and current consumption rate tables stored in the storage unit 180. In still other example embodiments, the control unit 110 may not take any measurements or perform any calculations. Instead, the control unit 110 may look up the PPR2 from a Power Performance Requirement table stored in the storage unit 180.

The time (i.e., Tn) required to decode the CB message and the current consumption rate (i.e., In) may vary depending on the specific RAT (i.e., RATn) being used. Some RATs may allow for faster decoding of a CB message (i.e., require a smaller Tn value), but may consume more current (i.e., require a larger In value). Conversely, some RATs may require longer times (i.e. require a larger Tn value) to decode a CB message, but require more current (i.e., require a smaller In value). For example, one RAT (RAT1) may allow decoding in 14.9 milliseconds (ms) (i.e., T1=14.9 ms) and require a current consumption rate of 47.3 milliamps (mA) (i.e., I1=47.3 mA) for a PPR1 value of 704.8 ms*mA (i.e., PPR1=704.8 ms*mA). Conversely, another RAT (RAT2) may require 15.4 ms (i.e., T2=15.4 ms) to decode a CB message with a current consumption rate of 39.5 mA (i.e., I2=39.5 mA) for a power performance requirement of 608.3 ms*mA (i.e., PPR2=608.3 ms*mA).

At block 225, the control unit 110 may determine if Sub1 192 is currently active. If the control unit 110 determines that Sub1 192 is currently active (i.e., 225-Y), the control unit 110 may select the RAT on Sub1 192 to decode the CB message and ignore the second CB schedule at block 230. For example, the control unit 110 may control the communication unit 120 to keep Sub1 192 in the active state and not tune away to Sub2 197. At block 235, the control unit 110 may cause the communication unit 120 to decode the CB message using the RAT on Sub1 192.

Conversely, if the control unit 110 determines that Sub1 192 is not currently active (i.e., 225-N), the control unit 110 may determine if Sub2 197 is currently active at block 240. If the control unit 110 determines that Sub2 197 is currently active (i.e., 240-Y), at block 245, the control unit 110 may select the RAT on Sub2 197 to decode the CB message and ignore the first CB schedule. For example, the control unit 110 may control the communication unit 120 to keep Sub2 197 in the active state and not tune away to Sub1 192. At block 250, the control unit 110 may cause the communication unit 120 to decode the CB message using the RAT on Sub2 197.

Conversely, if the control unit 110 determines that Sub2 197 is not currently active (i.e., 240-N), the control unit 110 may determine if the PPR1 of Sub1 192 is greater than the PPR2 of the second subscription (e.g., Sub2 197) at block 255. If the control unit 110 determines that PPR1 is greater than PPR2 (i.e., 255-Y), at block 260 the control unit 110 may select the RAT on Sub2. 197 to decode the CB message and ignore the first CB schedule. For example, the control unit 110 may control the communication unit 120 may not use Sub1 192 for decoding the CB message. At block 265, the control unit 110 may cause the communication unit 120 to decode the CB message using the RAT on Sub2 197.

Conversely, if the control unit 110 determines that PPR1 is not greater than PPR2 (i.e., 255-N), at block 270 the control unit 110 may select the RAT on Sub1 192 to decode the CB message and ignore the second CB schedule. For example, the control unit 110 may control the communication unit 120 to not use Sub2 197 for decoding the CB message. At block 280, the control unit 110 may cause the communication unit 120 to decode the CB message using the RAT on Sub1 192.

While in the embodiments explained above the control unit 110 selects a subscription to decode a CB message based on determinations made at blocks 225, 240 and 255, various embodiments may not make all of these determinations and some embodiments may omit one or more of the determinations illustrated in blocks 225, 240 and 255. Further, various embodiments need not make these determinations in the order illustrated and may make the determinations in any order that may be apparent to a person of ordinary skill in the art.

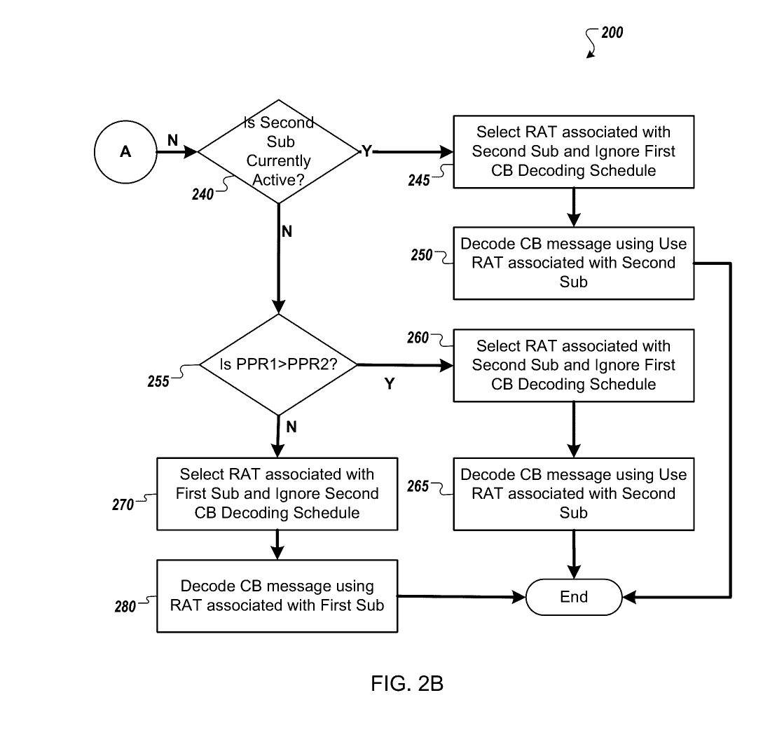

FIG. 3 is a diagram 300 illustrating scheduled RAT activity on an inactive subscription (e.g., Sub2 197 in FIGS. 1A-1B) of a mobile communication device 100 according to various embodiments. With reference to FIGS. 1A-3, the diagram 300 illustrates that the scheduled RAT activity on inactive Sub2 197 includes scheduled paging tune away events 305 during which the control unit 110 is scheduled to control the communication unit 120 to tune to the inactive Sub2 197 to determine if any paging requests have been issued by the communication network (e.g., the second communication network 195) associated with the inactive Sub2 197. During the schedule paging tune away events 305, the control unit 110 is scheduled to cause the communication unit 120 to tune to Sub2 197 to retrieve a data packet addressed specifically to the mobile communication device 100 from the Second Communication Network 195.

The scheduled RAT activity also includes scheduled CB message decoding tune away events 310 during which the control unit 110 is scheduled to control the communication unit 120 to tune to the inactive Sub2 197 to determine if any CB broadcast messages have been issued by the communication network (e.g., Second Communication Network 195). These scheduled CB message decoding tune away events 310 may be ignored based on various embodiments of the present application.

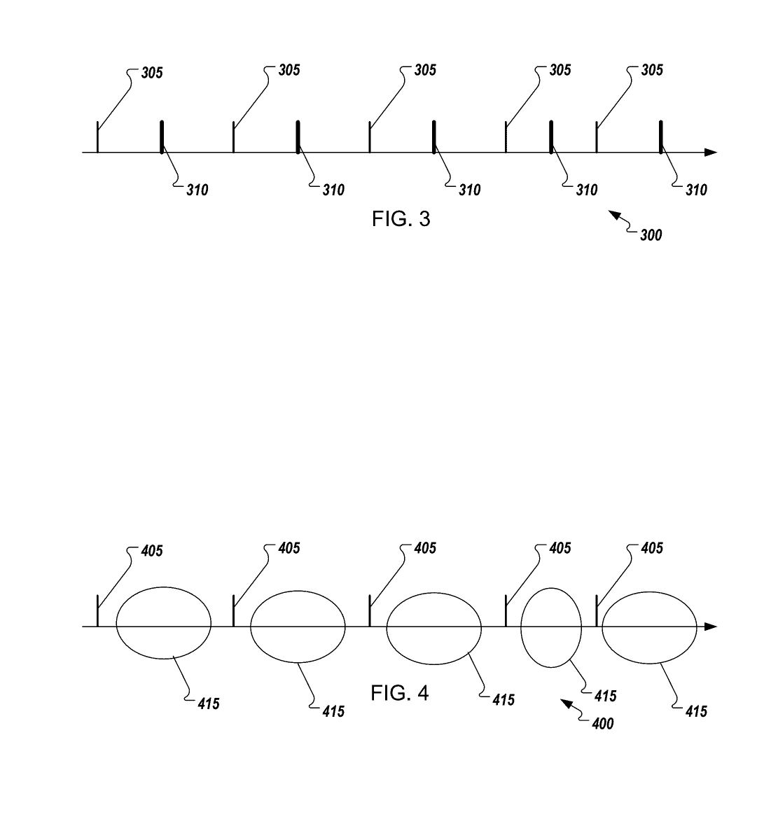

FIG. 4 is a diagram 400 illustrating actual RAT activity of an inactive subscription (e.g., Sub2 197 in FIGS. 1A-1B) of a mobile communication device (e.g., 100 in FIGS. 1A-1B) according to various embodiments. With reference to FIGS. 1A-4, the diagram 400 the illustrates that actual RAT activity of inactive Sub2 197 includes paging tune away events 405 during which the control unit 110 controls the communication unit 120 to tune to the inactive Sub2 197 to the Second Communication Network 195. During the paging tune away events 405, the control unit 110 causes the communication unit 120 to tune to Sub2 197 to retrieve a data packet addressed specifically to the mobile communication device 100 from the Second Communication Network 195.

The actual RAT activity also in CB message tune away gaps 415. During the tune away gaps 415, which correspond to scheduled CB message decoding tune away events, the control unit 110 ignores scheduled CB message decoding tune away events and controls the communication unit 120 to remain tuned to the active subscription (e.g., Sub1 192) and use the active Sub1 192 for any required CB message decoding.

The method 200 may be embodied on a non-transitory computer readable medium, for example, but not limited to, the storage unit 180 or other non-transitory computer readable medium known to those of skill in the art, having stored therein a program including computer executable instructions for making a processor, computer, or other programmable device execute the operations of the methods.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The accompanying claims and their equivalents are intended to cover such forms or modifications as would fall within the scope and spirit of the protection. For example, the example apparatuses, methods, and systems disclosed herein can be applied to both single-SIM wireless devices as well as multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations: these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) Of other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for decoding a cell broadcast (CB) message in a multi subscriber identity module (SIM) mobile communication device, the method comprising:
receiving a first CB decoding schedule for a first subscription associated with a first radio access technology (RAT) of the mobile communication device;
receiving a second CB decoding schedule for a second subscription associated with a second RAT of the mobile communication device;
selecting one subscription from the first subscription and the second subscription; and
decoding a CB message on a RAT associated with the selected subscription in accordance with a CB decoding schedule of the selected subscription.

2. The method of claim 1, wherein the selecting the one subscription from the first subscription and the second subscription comprises:
determining whether the first RAT associated with the first subscription is actively being used to access a first communication network; and
selecting the first subscription based on determining that the first RAT is actively being used to access the first communication network.

3. The method of claim 2, wherein the decoding the CB message on the RAT associated with the selected subscription comprises:
decoding the CB message on the first RAT associated with the first subscription in accordance with the first CB decoding schedule.

4. The method of claim 3, wherein the decoding the CB message on the RAT associated with the selected subscription comprises:
ignoring the second CB decoding schedule for the second subscription associated with the second RAT.

5. The method of claim 2, wherein the selecting the one subscription from the first subscription and the second subscription further comprises:
determining whether the second RAT associated with the second subscription is actively being used to access a second communication network; and
selecting the second subscription based on determining that the second RAT is actively being used to access the second communication network.

6. The method of claim 5, the decoding the CB message on the RAT associated with the selected subscription comprises:
decoding the CB message on the second RAT associated with the second subscription in accordance with the second CB decoding schedule.

7. The method of claim 6, wherein the decoding the CB message on the RAT associated with the selected subscription comprises:
ignoring the first CB decoding schedule for the first subscription associated with the first RAT.

8. The method of claim 5, further comprising, in response to determining that both the first subscription and the second subscription are not actively being used:
determining a first power performance requirement (PPR) of the first RAT associated with the first subscription, the first PPR being indicative of power required to access the first communication network using the first RAT; and
determining a second PPR of the second RAT associated with the second subscription, the second PPR being indicative of power required to access the second communication network using the second RAT.

9. The method of claim 8, wherein the selecting the one subscription from the first subscription and the second subscription further comprises:
determining whether the first PPR of the first RAT is greater than the second PPR of the second RAT;
selecting the first subscription in response to determining that the first PPR of the first RAT is not greater than the second PPR of the second RAT; and
selecting the second subscription in response to determining that the first PPR of the first RAT is greater than the second PPR of the second RAT.

10. The method of claim 9, wherein the decoding the CB message on the RAT associated with the selected subscription comprises:
decoding the CB message on the first RAT associated with the first subscription in accordance with the first CB decoding schedule in response to the selecting the first subscription; and
decoding the CB message on the second RAT associated with the second subscription in accordance with the second CB decoding schedule in response to the selecting the second subscription.

11. The method of claim 1, further comprising:
determining a first power performance requirement (PPR) of the first RAT associated with the first subscription, the first PPR being indicative of power required to access a first communication network using the first RAT; and
determining a second PPR of the second RAT associated with the second subscription, the second PPR being indicative of power required to access a second communication network using the second RAT.

12. The method of claim 11, wherein the selecting the one subscription from the first subscription and the second subscription further comprises:
determining whether the first PPR of the first RAT is greater than the second PPR of the second RAT;
selecting the first subscription based on determining that the first PPR of the first RAT is not greater than the second PPR of the second RAT; and
selecting the second subscription based on determining that the first PPR of the first RAT is greater than the second PPR of the second RAT.

13. The method of claim 12, wherein the decoding the CB message on the RAT associated with the selected subscription comprises:
decoding the CB message on the first RAT associated with the first subscription in accordance with the first CB decoding schedule in response to the selecting the first subscription; and
decoding the CB message on the second RAT associated with the second subscription in accordance with the second CB decoding schedule in response to the selecting the second subscription.

14. A multi-subscriber identity module (SIM) mobile communication device for decoding a cell broadcast (CB) message, the mobile communication device comprising:
a communication unit configured for communication with a first communication network using a first radio access technology (RAT) and communication with a second communication network using a second RAT; and
a control unit configured with processor-executable instructions to:
receive a first CB decoding schedule for a first subscription associated with the first RAT of the mobile communication device;
receive a second CB decoding schedule for a second subscription associated with the second RAT of the mobile communication device;
select one subscription from the first subscription and the second subscription; and
decode a CB message on a RAT associated with the selected subscription in accordance with a CB decoding schedule of the selected subscription.

15. The mobile communication device of claim 14, wherein the control unit is configured with processor-executable instructions to select the one subscription from the first subscription and the second subscription by:
determining whether the first RAT associated with the first subscription is actively being used to access the first communication network; and
selecting the first subscription based on determining that the first RAT is actively being used to access the first communication network.

16. The mobile communication device of claim 15, wherein the control unit is configured with processor-executable instructions to decode the CB message on the RAT associated with the selected subscription by:
decoding the CB message on the first RAT associated with the first subscription in accordance with the first CB decoding schedule.

17. The mobile communication device of claim 16, wherein the control unit is configured with processor-executable instructions to decode the CB message on the RAT associated with the selected subscription by:
ignoring the second CB decoding schedule for the second subscription associated with the second RAT.

18. The mobile communication device of claim 15, wherein the control unit is configured with processor-executable instructions to select the one subscription from the first subscription and the second subscription by:
determining whether the second RAT associated with the second subscription is actively being used to access the second communication network; and
selecting the second subscription based on determining that the second RAT is actively being used to access the second communication network.

19. The mobile communication device of claim 18, wherein the control unit is configured with processor-executable instructions to decode the CB message on the RAT associated with the selected subscription by:
decoding the CB message on the second RAT associated with the second subscription in accordance with the second CB decoding schedule.

20. The mobile communication device of claim 19, wherein the control unit is configured with processor-executable instructions to decode the CB message on the RAT associated with the selected subscription by:
ignoring the first CB decoding schedule for the first subscription associated with the first RAT.

21. The mobile communication device of claim 20, wherein, in response to determining that both the first subscription and the second subscription are not actively being used, the control unit is configured with processor-executable instructions to:
determine a first power performance requirement (PPR) of the first RAT associated with the first subscription, the first PPR being indicative of power required to access the first communication network using the first RAT; and
determine a second PPR of the second RAT associated with the second subscription, the second PPR being indicative of power required to access the second communication network using the second RAT.

22. The mobile communication device of claim 21, wherein the control unit is configured with processor-executable instructions to select the one subscription front the first subscription and the second subscription by:
determining whether the first PPR of the first RAT is greater than the second PPR of the second RAT;
selecting the first subscription in response to determining that the first PPR of the first RAT is not greater than the second PPR of the second RAT; and
selecting the second subscription in response to determining that the first PPR of the first RAT is greater than the second PPR of the second RAT.

23. The mobile communication device of claim 22, wherein the control unit is configured with processor-executable instructions to decode the CB message on the RAT associated with the selected subscription by:
decoding the CB message on the first RAT associated with the first subscription in accordance with the first CB decoding schedule in response to the selecting the first subscription; and
decoding the CB message on the second RAT associated with the second subscription in accordance with the second CB decoding schedule in response to the selecting the second subscription.

24. The mobile communication device of claim 14, wherein the control unit is configured with processor-executable instructions to:
determine a first power performance requirement (PPR) of the first RAT associated with the first subscription, the first PPR being indicative of power required to access the first communication network using the first RAT; and
determine a second PPR of the second RAT associated with the second subscription, the second PPR being indicative of power required to access the second communication network using the second RAT.

25. The mobile communication device of claim 24, wherein the control unit is configured with processor-executable instructions to select the one subscription front the first subscription and the second subscription by:
determining whether the first PPR of the first RAT is greater than the second PPR of the second RAT;
selecting the first subscription in response to determining that the first PPR of the first RAT is not greater than the second PPR of the second RAT; and
selecting the second subscription in response to determining that the first PPR of the first RAT is greater than the second PPR of the second RAT.

26. The mobile communication device of claim 25, wherein the control unit is configured with processor-executable instructions to decode the CB message on the RAT associated with the selected subscription by:
decoding the CB message on the first RAT associated with the first subscription in accordance with the first CB decoding schedule in response to the selecting the first subscription; and
decoding the CB message on the second RAT associated with the second subscription in accordance with the second CB decoding schedule in response to the selecting the second subscription.

27. A non-transitory computer readable medium having stored therein a program for making a computer execute a method for decoding a cell broadcast (CB) message in multi-subscriber identity module (SIM) mobile communication device, said program including computer executable instructions for performing operations comprising:
receiving a first CB decoding schedule for a first subscription associated with a first radio access technology (RAT) of the mobile communication device;
receiving a second CB decoding schedule for a second subscription associated with a second RAT of the mobile communication device;
selecting one subscription from the first subscription and the second subscription; and
decoding a CB message on a RAT associated with the selected subscription in accordance with a CB decoding schedule of the selected subscription.

28. The non-transitory computer readable medium of claim 27, wherein the selecting the one subscription from the first subscription and the second subscription comprises:
determining whether the first RAT associated with the first subscription is actively being used to access a first communication network;
selecting the first subscription based on determining that the first RAT is actively being used to access the first communication network; and
ignoring the second CB decoding schedule for the second subscription associated with the second RAT based on determining that the first RAT is actively being used to access the first communication network,

29. A multi-subscriber identity module (SIM) mobile communication device for decoding a cell broadcast (CB) message, the mobile communication device comprising:
means for receiving a first CB decoding schedule for a first subscription associated with a first radio access technology (RAT) of the mobile communication device;
means for receiving a second CB decoding schedule for a second subscription associated with a second RAT of the mobile communication device;
means for selecting one subscription from the first subscription and the second subscription; and
means for decoding a CB message on a RAT associated with the selected subscription in accordance with a CB decoding schedule of the selected subscription.

30. The mobile communication device of claim 26, wherein the means for selecting the one subscription from the first subscription and the second subscription comprises:
means for determining whether the first RAT associated with the first subscription is actively being used to access a first communication network;
means for selecting the first subscription based on determining that the first RAT is actively being used to access the first communication network; and
means for ignoring the second CB decoding schedule for the second subscription associated with the second RAT based on determining that the first RAT is actively being used to access the first communication network.
